(19) United States
(12) Patent Application Publication
(10) Pub. No.: US 2019/0037394 A1
(43) Pub. Date: Jan. 31, 2019

(54) METHOD FOR CALL SETUP

(71) Applicant: DIGITAL PRIVACY GMBH, 1010 Wien (AT)

(72) Inventor: Michael Walter, Wien (AT)

(21) Appl. No.: 16/080,892

(22) PCT Filed: Jan. 27, 2017
(86) PCT No.: PCT/EP2017/051752

§ 371 Date: Aug. 29, 2018

(30) Foreign Application Priority Data
Feb. 29, 2016 (EP) 16157768.9
Nov. 16, 2016 (EP) 16199065.0

(51) Int. Cl. H04W 12/02; H04W 4/16; H04M 3/42

(52) U.S. Cl. CPC H04W 12/02; H04W 4/16; H04M 2203/6009; H04M 3/42008; H04M 2203/558; H04M 3/42068

(57) ABSTRACT

A method for setting up a call from a subscriber having a first caller identification to a mobile station to which a first dial number in a first mobile network is assigned, comprising: storing an association between the first dial number and a second dial number assigned in a second mobile network, in a service node of the second mobile network; receiving a first call which is directed to the second dial number and contains the first caller identification, in the second mobile network; determining the first dial number associated with the second dial number from the stored association and generating a second caller identification comprising a network prefix of the second mobile network and the first caller identification; and, setting up a second call from the second mobile network, or another mobile or fixed network, to the mobile station and connecting the first call to the second call.

### CROSS-REFERENCE TO RELATED APPLICATION(S)

This application is a National Phase application of International Application No. PCT/EP 2017/051752 filed Jan. 27, 2017 which claims priority to the European Patent Application No. 16 157 768.9 filed Feb. 29, 2016 and European Patent Application No. 16 199 065.0 filed Nov. 16, 2016, the disclosures of which are incorporated herein by reference in their entireties.

### BACKGROUND

### Technical Field

The present subject matter relates to a method for setting up a call from a subscriber to a mobile station that is identified by a dial number in a mobile phone network.

In this description, the term “connection” or “call” shall be understood to mean a normal voice connection and even a mere signaling connection in the context of a “short message service” (SMS) from and to a mobile station, in particular according to a 2G, 4G, 5G or higher standard, such as GSM, UMTS, LTE, etc.

### Background Art

Dial numbers in mobile phone networks are increasingly used for identifying persons, whether in address books, business cards, advertisements, etc., or as a component of login or transaction data for internet services in which an access or transaction authorization is sent by returning a password to a user's mobile telephone that has been identified by the dial number in order to assure enhanced security of the user authentication. Due to such novel uses of mobile telephone dial numbers, however, the latter are increasingly made public, and the user ultimately no longer has any true understanding of or influence on which systems or recipients have obtained his personal dial number. Not only is this contrary to the need for data protection, it also keeps many users from using beneficial internet services based on increased authentication security by confirming a mobile telephone number because they want to protect their phone numbers.

Documents GB 2 454 886 A, US 2007/0064895 A1 and WO 03/024074 A2 each illustrate a method for using anonymous dial numbers. To this end, an association data base is implemented in the home network of a mobile phone subscriber in order to replace the dial number of the mobile phone subscriber issued in this mobile phone network with an anonymous dial number. Anonymous dial numbers are therefore only available for mobile phone subscribers whose home network has implemented such an association data base.

### BRIEF SUMMARY

The object of the disclosed subject matter is to overcome these drawbacks and to create call methods for subscribers of mobile phone networks that provide enhanced protection for their dial numbers.

This object is attained according to a first aspect of the disclosed subject matter with a method for setting up a call from a subscriber having a first caller identification to a mobile station to which a first dial number in a first mobile phone network is assigned, comprising:

storing an association between the first dial number and a second dial number assigned in a second mobile phone network, in a service node of the second mobile phone network;

receiving a first call which is directed to the second dial number and contains the first caller identification, in the second mobile phone network;

determining the first dial number associated with the second dial number from the stored association and generating a second caller identification comprising a network prefix of the second mobile phone network and the first caller identification; and,

setting up a second call from the second mobile phone network, or another mobile or fixed phone network, to the mobile station addressed by the first dial number and connecting the first call to the second call, wherein the second caller identification is transmitted in the second call.

Thus the disclosed subject matter creates, as it were, a “firewall” for the user of the mobile station in the first mobile phone network by “interposing” a second mobile phone network in which a second, “virtual” dial number is associated with the subscriber. The user may forward the second, virtual dial number without worrying that he is publicly disclosing his personal, first dial number to the public. The user may use the second, virtual dial number, for instance, as a telephone contact in public advertisements or in the context of login or transaction data for internet services that, e.g., return a confirmation SMS with passwords or transaction codes via the mobile phone network while simultaneously protecting his personal, first dial number from public disclosure.

In setting up a call according to the disclosed subject matter to the second, virtual dial number, the latter is translated to the personal first dial number by the service node of the second mobile telephone network, wherein transmitted simultaneously is a new (“second”) caller identification, which contains not only the original (“first”) caller identification of the calling subscriber, but also the network prefix of the second mobile phone network. Using this network prefix contained in the second caller identification, the called user may detect that the call is not his personal dial number, but instead his virtual dial number. The called user may thus decide, for example, whether or not he will answer the call directed to his virtual dial number. The disclosed method thus offers not only confidentiality and data protection, but also additional information about the calling subscriber, specifically, whether the calling subscriber has dialed the personal or the virtual dial number and thus to which private or public circle of acquaintances the calling subscriber belongs.

A correspondingly programmed mobile station may also automatically detect the network prefix of the second mobile phone network received in the second caller identification and also especially clearly indicate to the user during signaling of the incoming call the circumstances of the use of the virtual dial numbers, e.g. on the display or with a special ringtone for the mobile station.

The second call, initiated by the service node, may be set up via the second mobile phone network itself, or via another mobile phone network or POTS, to which the service node is connected.

One particularly advantageous refinement of the disclosed method furthermore comprises storing at least one further association between the first dial number and a respective further second dial number assigned in the second mobile phone network, in the service node, wherein for each stored association of a first dial number an association identifier is assigned, and wherein the second caller identification also comprises the association identifier.

The user of the mobile station may thus immediately use and output to different public circles a plurality of different virtual (second) dial numbers, for instance for different circles of acquaintances, different websites, different advertisements, etc. Then, at the mobile station, using the caller identification, which now also contains the association identifier for the specific called virtual dial number, not only is it possible to detect whether the caller dialed the personal or virtual dial number, but also which of the plurality of virtual dial numbers the caller used. In this way the called user obtains additional information about the public circle from which the caller comes, and may decide with even greater precision and selectivity whether or not he will take the call.

The disclosed method is especially simple to implement when the first call addressed to the second dial number is detected by means of the network prefix of the second mobile phone network and directed thereto, where it is received at a line of the second mobile phone network and from there connected to the second call. Because of this, a conventional traffic separation is sufficient based on the network prefix in order to direct the call addressed to the second dial number to the second mobile phone network.

Alternatively, the at least one virtual (second) dial number may be published in the entire telephone network and all of the mobile phone networks connected thereto in that it is registered in the home location register (HLR) of the second mobile phone network, if desired.

In the context of the disclosed method, very different call filter functions may optionally be executed in the service node for the benefit of the user of the mobile station. To this end the second call may only be set up and the first call only be connected to the second call when the first caller identification is included in an admission list (“whitelist”) or is not included in a blocking (“blacklist”), the admission list or blocking list, respectively, being stored in the service node with respect to the first dial number. In this way the user of the mobile station may be protected from undesired calls (“blacklisting”) or only desired calls are put through (“whitelisting”).

If the user of the mobile station has a plurality of virtual dial numbers, in this context the second call may also only be set up and the first call may only be connected if the first caller identification is contained in such an admission list or is not contained in such a blocking list that is stored in the service node for the first dial number.

The disclosed method also functions in the reverse direction for a call set-up from the mobile station to the subscriber, who is identified by his first caller identification, here also called a “further dial number,” and to this end comprises according to a second aspect of the disclosed subject matter:

storing an association between the first dial number and a second dial number assigned in a second mobile phone network in a service node of the second mobile phone network;

receiving a call which contains the further dial number in its destination dial number and the first dial number as caller identification, in the second mobile phone network;

extracting the further dial number from the destination dial number, determining the second dial number associated with the first dial number from the association stored in the service node, and generating a further caller identification comprising the second dial number; and,

setting up a further call from the second mobile phone network, or a further mobile or fixed phone network, to the subscriber addressed by the extracted further dial number and connecting the call to the further call, wherein the further caller identification is transmitted in the further call.

The method according to the second aspect of the disclosed subject matter again permits data protection and confidentiality for the personal dial number of the user of the mobile station, who is now the caller, in that the subscriber now called is signaled the virtual dial number of the user as the caller identification.

One advantageous embodiment of the method according to the second aspect of the disclosed subject matter is that it additionally includes:

storing at least one further association between the first dial number and a respective further second dial number assigned in the second mobile phone network, in the service node, wherein for each stored association of a first dial number an association identifier is assigned, and wherein the destination dial number also contains the association identifier;

wherein in the step of extracting also the association identifier is extracted from the destination dial number, and,

wherein in the step of generating the further caller identification the second dial number associated with the first dial number is determined by means of the association identified by the extracted association identifier.

In this embodiment, the calling user may now also indicate, by appropriately dialing the association identifier when calling out, that dial number of his virtual dial numbers that is signaled for the called subscriber as caller identification.

In order to receive in the second mobile phone network the call that contains the further dial number of the called subscriber in his destination dial number, this destination dial number optionally contains as prefix or at its beginning the network prefix of the second mobile phone network. A third aspect of the disclosed subject matter is based on the applicant's understanding that a destination dial number that contains both the network prefix of the second mobile phone network and the dial number of called subscriber, which latter itself contains the network prefix of its mobile phone network, may attain a significant place length, the complete transmission of which in the telephone network in many situations is no longer assured. To solve this problem, in a third aspect the disclosed subject matter creates an alternative call method from the mobile station to the subscriber, comprising:

storing an association between the first dial number and a second dial number assigned in a second mobile phone network, in a service node of the second mobile phone network;

receiving a call which contains a predetermined dial number in the second mobile phone network and/or a first part of the further dial number in its destination dial number and the first dial number as caller identification, in the second mobile phone network;

receiving a sequence of dialing tones, which sequence codes the second part of the further dial number and, if not already contained in the destination dial number, also the first part of the further dial number, via the received call, and decoding the sequence in the service node;

extracting the further dial number from the destination dial number and from the decoded sequence, determining the second dial number associated with the first dial number from the association stored in the service node, and generating a further caller identification comprising the second dial number, and,

setting up a further call from the second mobile phone network, or a further mobile or fixed phone network, to the subscriber addressed by the extracted further dial number and connecting the call to the further call, wherein the further caller identification is transmitted in the further call.

In this way the place length for the destination dial number for setting up the call from the mobile station to the second mobile phone network may be limited to a number of places, e.g. 16 digits, that may be transmitted in the telephone network, while the remaining digits of the destination dial numbers are transmitted to the subscriber as dialing tones via the call set up to the second mobile phone network in this manner. In the second mobile phone network, all of the information from the destination dial number obtained in the call set-up, on the one hand, and dialing tones sent in the call, on the other hand, may be combined in order to extract therefrom the destination dial number of the subscriber (including his network prefix) and an optional received association identifier. In analog telephony, the use of dialing tones is a proven, robust data transmission method for transmitting information via a call that is already set up. The method according to a third aspect of the disclosed subject matter thus again facilitates all of the aforesaid advantages of data protection and confidentiality for the personal dial number of the user of the mobile station.

This embodiment of the disclosed method may also optionally comprise:

storing at least one further association between the first dial number and a respective further second number assigned in the second mobile phone network, in the service node, wherein for each stored association of a first dial number an association identifier is assigned, and wherein either the destination dial number or the sequence also contains the association identifier;

wherein in the step of extracting also the association identifier is extracted; and,

wherein in the step of generating the further caller identification the second dial number associated with the first dial number is determined by means of the association identified by the extracted association identifier.

Thus the calling user may again, by also dialing the association identifier when calling out, also indicate that virtual dial number of his virtual dial numbers that is signaled to the called subscriber as caller identification.

The disclosed methods also facilitate at any time a call-back from the mobile station called at the virtual dial number to the original caller, because his caller identification does not become lost. In a fourth aspect, the disclosed subject matter thus also relates to a method for calling back the subscriber from the mobile station, i.e., following a call method according to the first aspect of the disclosed subject matter, comprising:

receiving a third call which contains the second caller identification as destination dial number and the first dial number as third caller identification, in the second mobile phone network;

extracting the first caller identification from the destination dial number; and,

setting up a fourth call from the second mobile phone network, or a further mobile or fixed phone network, to the subscriber addressed by the extracted first caller identification and connecting the third call to the fourth call.

The method here optionally also comprises determining the second dial number associated with the first dial number from the association stored in the service node and generating a fourth caller identification comprising the determined second dial number; wherein the fourth caller identification is transmitted in the fourth call.

In this way the called-back subscriber again obtains as caller identification the virtual, second dial number of the user of the mobile station, and his personal, first dial number remains hidden and protected. The called-back subscriber sees only the virtual dial number originally called by him and detects this as a normal call-back of the user of the mobile station.

In the embodiment of the call method according to the first aspect of the disclosed subject matter, in which a plurality of virtual dial numbers are associated in the second mobile phone network and an association identifier is assigned to each association, a further embodiment of the call-back method furthermore comprises:

extracting also the association identifier from the destination dial number; and,

determining the second dial number associated with the first dial number by means of the association identified by the extracted association identifier.

In this case, as well, during the call-back it is exactly the virtual dial number used by the original caller that is signaled as caller identification of the person calling back, so that the call-back appears consistent and transparent for the person being called back without the personal dial number of the user of the mobile station being made public.

Both during calling and during call-back of the subscriber by the mobile station according to the second, third, or fourth aspect of the disclosed subject matter, the call of the mobile station may be detected by means of the network prefix of the second mobile phone network and directed thereto, where it is received at a line of the second mobile phone network and connected from there to the further or fourth call, so that for this only a traffic separation using the network prefix of the second mobile phone network is sufficient.

The at least one virtual second dial number may be a dial number directly assigned in the second mobile phone network, or may also be a dial number that has been dial number ported into the second mobile phone network from a further mobile phone network. It is understood that such dial number porting means that this virtual second dial number must be entered in the HLR of the other mobile phone network from which porting occurred as the ported dial number, such as e.g. is defined in the case of a GSM network in the corresponding ETSI standards about dial number porting.

In each of the described variants of the method, the second mobile phone network may be a conventional, hardware-based mobile phone network (“Mobile Network Operator,” MNO), or alternatively may be virtualized as a “Mobile Virtual Network Operator” (MVNO) in a third, hardware-based MNO mobile phone network.

### BRIEF DESCRIPTION OF THE DRAWINGS/FIGURES

The disclosed subject matter shall be explained in greater detail in the following using exemplary embodiments depicted in the attached drawings, in which:

FIGS. 1 and 2 depict the methods according to the disclosed subject matter using a call set-up of a calling subscriber to a called mobile station (FIG. 1), and in the opposite direction and also as a call-back (FIG. 2), in each case in the form of a schematic block diagram with illustrated call set-up signal flows;

FIG. 3 depicts an alternative embodiment of the disclosed method for the call set-up or call-back from the mobile station to the subscriber, again in the form of a schematic block diagram with illustrated call set-up signal flows; and,

FIG. 4 depicts further variants of the methods from FIGS. 1 through 3 in the same manner.

### DETAILED DESCRIPTION

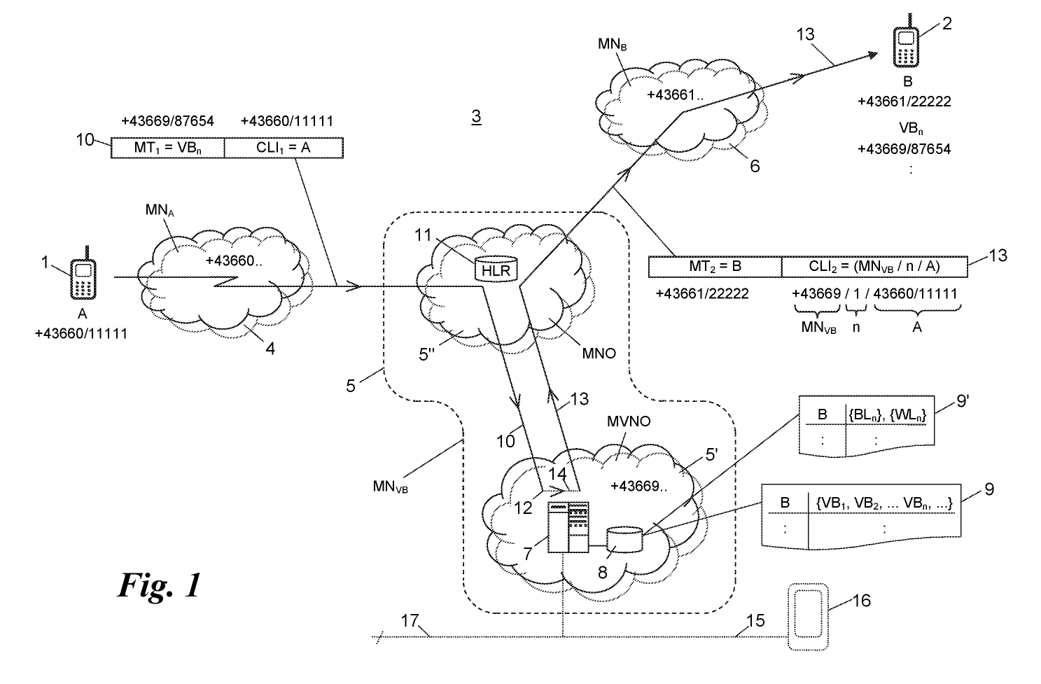

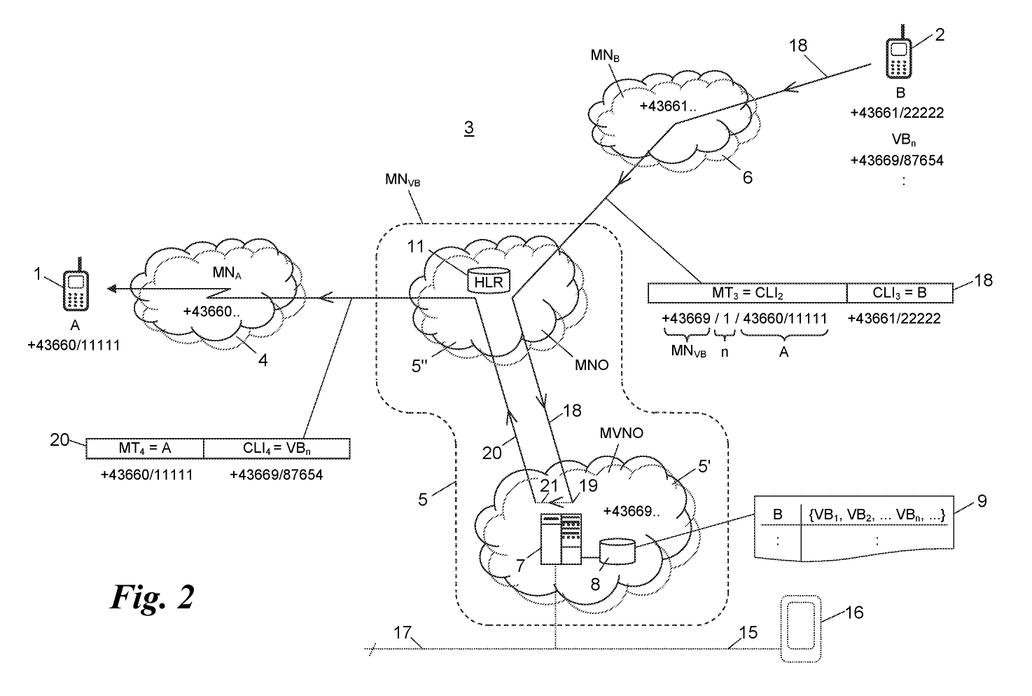

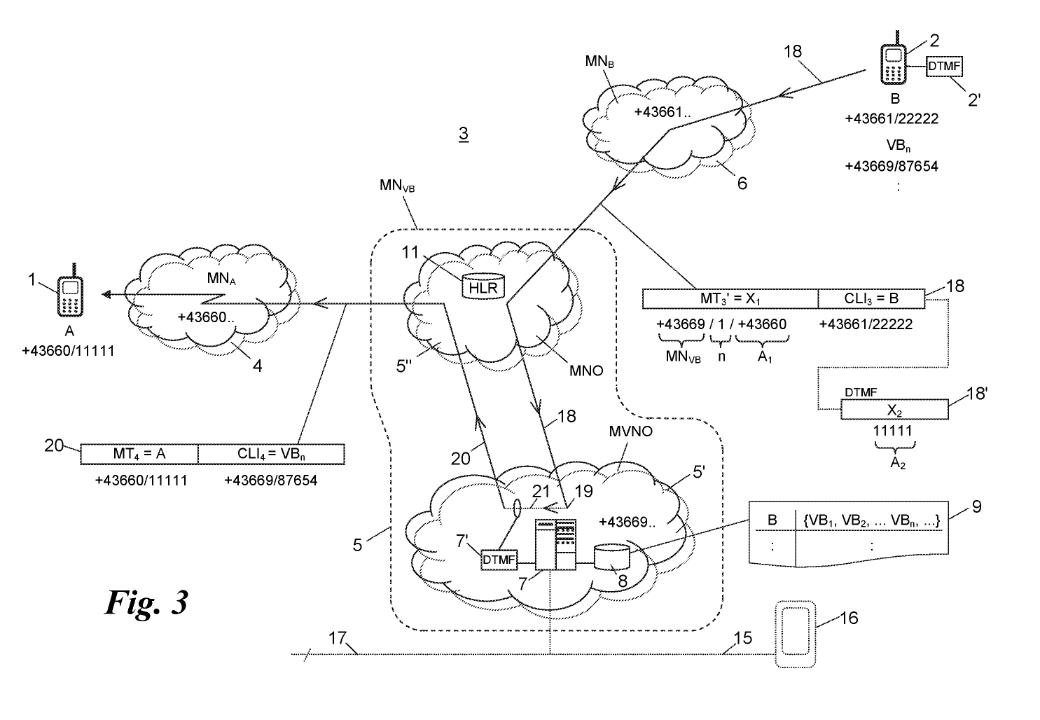

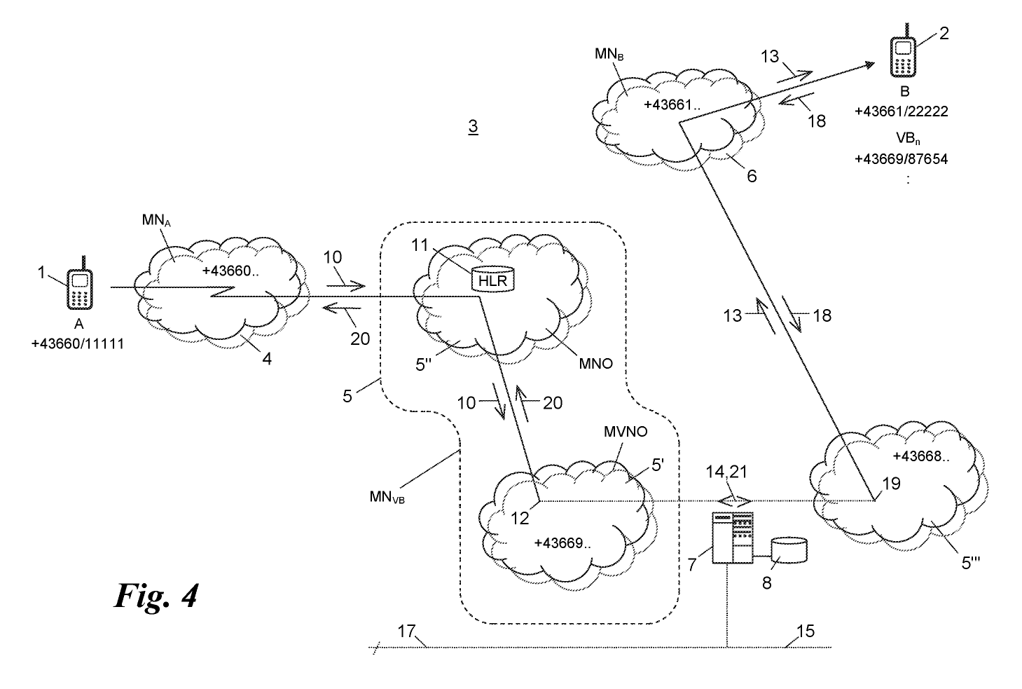

FIGS. 1 through 4 depict methods for connecting a first subscriber 1 to a second subscriber 2 via a telephone network 3, which is composed of a number of mobile or fixed phone networks connected to one another, of which three mobile phone networks 4, 5 and 6 are depicted as an example. FIG. 1 depicts the method for setting up a call from the calling subscriber 1 to the called subscriber 2, FIGS. 2 and 3 depict the method for setting up a call or call-back from subscriber 2, now calling, to subscriber 1, now called, and FIG. 4 depicts variants of the methods from FIGS. 1 through 3.

The network 6 of the subscriber 2 is a mobile phone network using a 2G, 3G, 4G, 5G, or higher standard, such as GSM, UMTS, LTE, or the like. The subscriber 2 in the mobile network 6 is consequently a mobile station, for example a mobile telephone, a smartphone, etc.

The mobile phone network 6 may be addressed in the entire telephone network 3 via its network prefix MN_{B}, in the present example the network prefix “+43661.” The subscriber or the mobile station 2 may be addressed in the telephone network 3 using his/its dial number B, which includes the network prefix MN_{B}, in the present example the dial number “+43661/22222.” This dial number B assigned to the mobile station 2 in the mobile phone network 6 is also referred to in the following as the “first” or “personal” dial number of the mobile station 2.

Similarly, the subscriber 1, in the illustrated example again a mobile station in a mobile phone network 4 having the network prefix MN_{A}, e.g. “+43660,” is identified by his or its dial number A, in this case “+43660/11111.” For the purposes of the present method, however, it is not necessary for the network 4 to be a mobile phone network and the subscriber 1 to be a mobile station; the network 4 of the subscriber 1 could also be a fixed phone network (“Plain Old Telephone System”, POTS) having the capability of transmitting caller line identifications (CLI), or could be a VoIP (Voice over IP) network connected to the telephone network 3 and in which the subscriber 1 is e.g. an internet telephone or internet terminal.

The network 5 of the telephone network 3 connecting the networks 4 and 6 in the call and call-back situations in FIGS. 1 through 4 is itself, like the mobile phone network 6 of the mobile station 2, a mobile phone network according to a 2G, 3G, 4G, 5G, or higher standard, such as GSM, UMTS, LTE, and the like. The mobile phone network 5 may be addressed in the telephone network 3 by its network prefix MN_{VB}, in the present example the network prefix “+43669.” The mobile phone network 5 is also referred to as the “second” mobile phone network in the following.

In the example shown, the mobile phone network 5 is implemented in the form of a “Mobile Virtual Network Operator” (MVNO) 5′ in a third mobile phone network 5″ (“virtualized”) that provides the hardware infrastructure for the MVNO network 5′. The task distribution between MVNO network 5′ and MNO network 5″ of the mobile phone network 5 may be different depending on the degree of virtualization or portion of infrastructure that the MNO network 5″ provides for the MVNO network 5′, as it is known as virtualization steps “thick,” “thin” and “skinny,” or “full” and “light” for MVNOs in engineering. However, it is understood that the mobile phone network 5 may also be realized without virtualization division into the networks 5′ and 5″ using a single mobile phone network according to the aforesaid standards.

The mobile phone network 5 contains at least one service node 7 having a data base 8 integrated therein or attached thereto. The service node 7 in the example shown is registered in the MVNO network 5′, but may alternatively also be registered in the infrastructure-providing MNO network 5″, or may also be distributed across both networks 5′, 5″. In a mobile phone network 5 according to the GSM, UMTS or LTE standard, the service node 7 is implemented for example in the central Mobile Services Switching Center (MSC) of the mobile phone network 5 or is connected thereto via a data connection.

To protect the personal dial number B of the mobile station 2 from calling or called subscribers such as the subscriber 1, the following steps are executed using the components depicted.

In a first step preceding the call from the subscriber 1 to the mobile station 2 (or vice versa), one or more second, “virtual” dial numbers VB₁, VB₂, . . . , in general VBₙ, are associated with the mobile station 2, more specifically to its first, personal dial number B, in the second mobile phone network 5. The dial number “+43669/87654” is used here as an example of such a virtual dial number VBₙ in the second mobile phone network 5. The association is stored in the data base 8 of the service node 6 of the mobile phone network 5 in an association table 9. Each association B↔VB₁, B↔VB₂, . . . , B↔VBₙ, . . . is simultaneously identified by its association identifier 1, 2, . . . , in general n. It is understood that in the simplest case of only a single association B↔VB the association identifier n is not necessary and may be omitted.

The virtual dial number VBₙ may be published by the user of mobile station 2 without any misgivings and forwarded to third parties, e.g. to the subscriber 1, since the mobile phone network 5 and the further steps of the described method protect or anonymize his personal dial number B in the mobile phone network 6. If the subscriber 1 wants to call the mobile station 2, he dials the virtual dial number VBₙ that was made known to him by the user and that contains the network prefix MN_{VB} of the second mobile phone network 5 as the prefix. This sets up a first call 10 from the subscriber 1 to the mobile phone network 5, which as destination dial number (Mobile Target) MT₁ contains the nth virtual dial number VBₙ of the mobile station 2 and as caller identification (Caller Line Identification) CLI₁ contains the dial number A of the subscriber 1.

The first call 10 is directed in the telephone network 3 to the mobile telephone network 5 by means of the network prefix NM_{VB} (separated from traffic). Alternatively, the virtual dial number VBₙ may have been made known in the telephone network 3, e.g. by feeding it into a Home Location Register (HLR) 11 of the mobile phone network 5. In GSM, UMTS, or LTE networks, such an entry in the HLR is distributed in a standard conforming manner in the telephone network 3 or to all mobile phone networks contained therein in order to display the home of the dial number VBₙ in the mobile phone network 5 and thus to display its jurisdiction so that the call 10 is directed to the mobile phone network 5.

The call 10 is received or terminated in the mobile radio network 5 at an internal or virtual line 12 thereof, with the involvement of the service node 7. The service node 7 now extracts from the destination dial number MT₁ contained in the signaling of the first call 10 the virtual dial number VBₙ, looks the latter up in the association table 9, and determines therefrom the associated personal dial number B, as well as (if a plurality of virtual dial numbers VBₙ are associated with it), the identifier n for the specific association VBₙ↔B. In addition, the service node 7 generates a new (“second”) caller identification CLI₂ from the network prefix MN_{VB} of the mobile phone network 5 and the first caller identification CLI₁, with the optional addition of the association identifier n.

Then the service node 7 initiates the set-up of a second call 13 proceeding from the mobile phone network 5 to the mobile station 2, in the mobile network 6, identified by the dial number B. The destination dial number MT₂ of the second call 13 is the dial number B, and the newly generated second caller identification CLI₂ is transmitted as caller identification.

Once the second call 13 has been set up (or even during it), the service node 7 connects the first call 10 that terminates in the mobile phone network 5 to the second call 13, i.e., it connects the voice data for the first call 10 to the voice data for the second call 13 or forwards SMS data from the first call 10 as SMS data in the second call 13 (see the connection 14).

While the first call 10 is being received, the second call 13 is being set up, and/or the connection 14 from the first call 10 to the second call 13 is being established, the service node 7 may also conduct filter functions with respect to caller identifications CLI₁ desired or not desired by the user of the mobile station 2, so-called “whitelisting” or “blacklisting,” in order to protect the user of the mobile station 2 from undesired calls or to connect only desired calls. To this end, one (or more) admission lists (“whitelists”) WLₙ of first caller identifications CLI₁ (dial numbers A) that are supposed to be connected (all others are blocked) may be stored in the service node 7 or its data base 8 for the personal dial number B of the mobile station 2, or one (or more) blocking lists (“blacklists”) BLₙ of such first caller identifications CLI₁ (dial numbers A) that are not permitted to be connected (all others are connected), i.e., for which no connection 14 is made and consequently no second call 13 has to be set up either.

In the case of a plurality of virtual dial numbers VBₙ, different admission lists WLₙ and blocking lists BLₙ may also be used, and specifically depending on a determined association n, as results from the virtual dial number VBₙ dialed by the subscriber 1. In this case, then, the admission list WLₙ or blocking list BLₙ associated with the dialed virtual dial number VBₙ, is selected from the data base 8 and then there is a check of whether the caller identification CLI₁ of the first call 10 is contained therein or not. Only if it is contained in the admission list WLₙ and is not contained in the blocking list BLₙ is the second call 13 set up and the first call 10 connected to the second call 13 (connection 14); otherwise, the first call 10 remains terminated on the line 12 of the mobile phone network 5 or is aborted. Optionally, the calling subscriber 1 may also obtain a corresponding voice message that the service node 7 adds to the line 12.

The admission lists WLₙ and/or blocking lists BLₙ may be stored in a discrete association table 9′ of the service node 7 or its data base 8, or in the same association table 9 in which the associations B↔VBₙ, are also stored; for example, the specific list WLₙ and/or BLₙ could be stored with every individual association B↔VBₙ.

In the method presented, such “blacklisting” or “whitelisting” even functions for calls 10 from the subscriber 1 that are set up with a “dial number suppression.” According to conventional CLI telephone standards, such a dial number suppression does not remove the caller identification CLI₁ from the call 10, but rather identifies the caller identification CLI₁ in the call 10 merely with a flag as “suppressed”; the flag is normally not evaluated until in the last sub-network of the telephone network 3 when the call is provided to the called subscriber and there then suppresses the caller identification. The caller identification CLI₁ is thus in any case still available in the interposing mobile phone network 5 and therefore in the service node 7 and may be evaluated for the aforesaid blacklisting and whitelisting functions.

Since each call 13 that comes into the mobile station 2 is detectable by the network prefix MN_{VB} of the mobile phone network 5 contained in the second caller identification CLI₂ as a call directed to the virtual dial number VBₙ, of the mobile station 2, the user of the mobile station 2 may also decide, using the caller identification CLI₂, whether or not he wants to receive such a call. If the mobile station 2 has a plurality of virtual dial numbers VBₙ, using the association identifier n also transmitted the user may also detect the specific public circle to which he disclosed the specific virtual dial number VBₙ.

The mobile station 2 may also be programmed e.g. as a smartphone such that it automatically detects the network prefix MN_{VB} of the mobile phone network 5 in the caller identification CLI₂ and to this end executes special processing steps for such a call, e.g. a special visual or acoustic signaling, a unique graphic display of the association identifier n, a special recording of the call, an individual voice message of a responder to a call, etc.

Such individual voice messages for the specifically dialed virtual dial number VBₙ may also already be added by the service node 7 itself into the line 12 terminating the first call 10, e.g. if the user of the mobile station 2 does not answer the second call 13 within a defined period of time, misses the call, or intentionally does not pick up. Such an individual voice message or call response function, i.e., depending on the dialed virtual dial number VBₙ, may therefore be performed both using the association identifier n contained in the caller identification CLI₂ and directly in the service node 7 using the dial number VBₙ contained in the destination dial number MT₁.

Via an (optional) data connection 15, the user of the mobile station 2 may also administer all of his virtual dial numbers VBₙ in the mobile phone network 5 himself, e.g. register (retrieve), deactivate or delete, etc., for example from an Internet terminal 16. The terminal 16 may be formed directly by the mobile station 2, as well, for instance if the mobile station 2 is an Internet-capable smartphone if it has a data connection 15 to the mobile phone network 5 or its service node 7. The user may also manage the admission lists WLₙ and blocking lists BLₙ for the filter functions of the service node 7 via the data connection 15 and the Internet terminal 16 (or a corresponding terminal application in the mobile station 2).

To satisfy all types of regulatory terms with respect to traceability of connections, the service node 7 may also optionally have an enforcement interface 17 for authorities to have access to the association table 9.

FIG. 2 depicts the method for setting up a call or a call-back from the mobile station 2 to the subscriber 1. First the call-back situation shall be explained using the second caller identification CLI₂, which was obtained in the mobile station 2 during the course of the second call 13 from FIG. 1.

In the call-back, the second caller identification CLI₂ is used as a new destination dial number MT₃ in a third call 18. Using the network prefix MN_{VB} of the mobile phone network 5 contained therein, the third call 18 is directed in the telephone network 3 to the mobile phone network 5 (separated from traffic) and there is terminated again using the service node 7 on an internal or virtual line 19 of the mobile phone network 5.

The service node 7 now extracts the dial number A contained in the destination dial number MT₃, i.e. the first caller identification CLI₁ from the first call 10, e.g. simply by removing the network prefix MN_{VB} and the optional association identifier n, sets up a fourth call 20 from the mobile phone network 5 to the subscriber 1, and connects the third call 18 to the fourth call 20 in terms of the voice or SMS data transported therein (see connection 21).

The fourth call 20 may either occur with suppressed caller identification, or, optionally, may contain a new, fourth caller identification CLI₄ that the service node 7 generated as follows. From the caller identification CLI₃ that was transmitted by the mobile station 2 in the third call 18 and that is the same as the personal dial number B of the mobile station 2, and, optionally, the association identifier n contained in the destination dial number MT₃ the service node 7 searches the association table 9 for the association B↔VBₙ identified by the association identifier n (or, if there is no association identifier, the single association B↔VB) and uses the virtual dial number VBₙ determined in this way as the new caller identification CLI₄ in the fourth call 20.

The user on the end device 1 thus is signaled with a call-back 20 that indicates as the caller identification CLI₄ precisely the virtual dial number VBₙ that he used early in his first call (FIG. 1). The call and call-back method in FIGS. 1 and 2 is therefore completely transparent for the subscriber 1, without revealing the personal dial number B of the mobile station 2, and also permits a data-protected call-back from the mobile station 2 to the subscriber 1.

The sections for a call-back from the mobile station 2 to the subscriber 1 illustrated in FIG. 2 also apply likewise for a first call from the mobile station 2 to the subscriber 1, i.e. if it is not a call-back, with the sole difference that the dial number A identified in the destination dial number MT₃ of the third call 18 was not obtained in advance in the second call 13, but instead is a desired dial number A dialed by the user on the mobile station 2. The destination dial number MT₃=MN_{VB}/n/A is again composed by dialing the network prefix MN_{VB}—and optionally the association identifier n—before the desired dial number. Using the network prefix MN_{VB} in the destination dial number MT₃, the call 18 is directed to the mobile phone network 5; there the personal dial number B of the calling mobile station 2 is extracted from the caller identification CLI₃, the associated virtual dial number VBₙ, is found in the association table 9, optionally using the association identifier n extracted from the destination dial number MT₃, and signaled to the called subscriber 1 as new caller identification CLI₄ in the fourth call 20.

When the destination dial numbers MT₃ for the call 18 are composed, the network prefix MN_{VB} and the (optional) association identifier n are manually placed in front (dialed first) of the dial number A by the user on the mobile station 2. Alternatively, this may also be accomplished automatically in the mobile station 2, for example using an appropriately programmed application in the mobile station 2 that automatically adds the network prefix MN_{VB} of the protected mobile phone network 5 for such “data protected” calls 18. In the case of a plurality of virtual dial numbers VBₙ, the application may also offer the user a dialing option for the desired virtual dial number VBₙ, that is intended to signal the subscriber 2 as a caller identification CLI₄, for example in the form of the specific association identifier n that the user of the mobile station 2 dials for the call to be actuated in the application.

FIG. 3 depicts an alternative embodiment of the call or call-back method in FIG. 2, wherein only the differences from FIG. 2 are addressed in the following; the above and the method from FIG. 3 may be combined with all of the aforesaid features of the embodiments in FIGS. 1 and 2 for all of the other aspects of the method of the method of FIG. 3.

FIG. 3 illustrates the use of an abbreviated destination target number MT₃′ instead of the destination target number MT₃ for the call 18 from the mobile station 2 to the mobile phone network 5 in order to accommodate any limitations on the number of places for destination dial numbers in the telephone network 3.

To this end, the destination dial number MT₃ is divided into a first part X₁ corresponding to the abbreviated destination dial number MT₃′, and a remaining second part X₂, i.e. MT₃=X₁+X₂=MT₃′+X₂. The designators “first” part and “second” part for the parts X₁ and X₂ of the dial number MT₃ should not be understood to be sequential; on the contrary, the one part X₁ may comprise any desired subset of places or digits in the destination dial number MT₃, and the other part X₂ may then comprise the remaining places or digits in the destination dial number MT₃.

So that the call 18 may be received in the second mobile phone network 5, the first part X₁ or the abbreviated destination dial number MT₃′ contains either the network prefix MN_{VB} of the second mobile phone network 5 (so that the call 18 in the telephone network 3 to the mobile phone network 5 may be traffic separated) or a predetermined dial number C assigned in the second mobile phone network 5 that is distributed via the Home Location Register (HLS) 11 of the mobile phone network 5 in the entire telephone network 3 in order to be able to direct the call 18 to the mobile phone network 5.

The first part X₁ may furthermore optionally contain the association identifier n and a first part (subset) A₁ of the dial number A of the subscriber 1, for instance its first digits, here its prefix part “+43660.” The second part X₂ of the divided destination dial numbers MT₃ then contains the rest (subset) A₂ of the dial number A of the subscriber 1, here, for example, the digits “11111” after the prefix. If the first part A₁ of the dial number A is not already contained in the first part X₁ der, however, then it is also in the second part X₂, i.e., the second part X₂ then contains the entire dial number A=A₁+A₂. The optional association identifier n may also be in the second part X₂ instead of in the first part X₁.

The first part X₁ of the destination dial number MT₃ is now used as abbreviated destination dial number MT₃′ for setting up the call 18 from the mobile station 2 to the line 19 of the mobile phone network 5, analogous to FIG. 2. The second part X₂ of the destination dial number MT₃, on the other hand, is transmitted as a sequence 18′ of dialing tones according to a multifrequency dialing method (MFV), also known as a DTMF method (Dual-Tone Multi-Frequency), via the set-up call 18 to the line 19 of the service node 7.

The sequence 18′ of dialing tones may be triggered, for example, by the user of the mobile station 2 activating corresponding selector keys via a selector key generator 2′ arranged in the mobile station 2, or an appropriately programmed application in the mobile station 2 dials the dialing tone sequence 18′ automatically, as it were, once the call has been set up.

A dialing tone decoder 7′ in the service node 7 now decodes the dialing tone sequence 18′ received in the call 18 on the line 19 in order to regenerate therefrom the information portion X₂ of the destination dial number MT₃. By combining the parts X₁ and X₂, i.e. MT₃′ and X₂, the entire destination dial number MT₃ is now regenerated in the service node 7 and, as in FIG. 2, the dial number A, and optionally the association identifier n, is extracted therefrom; the other steps proceed as described for FIG. 2.

FIG. 4 depicts further alternative embodiments of the methods from FIGS. 1 through 3, wherein here, for better understanding, only the subscribers, networks, and call connections involved are illustrated, but both for the call situation in FIG. 1 and the call-back situation in FIGS. 2 and 3. Provided there is no description to the contrary in the following, all components, functions, and method processes in FIG. 4 are as described in the foregoing for FIGS. 1 through 3.

According to FIG. 4, when a call from the subscriber 1 to the subscriber 2 is being set up, the second call 13 is also set up via a different mobile or fixed phone network 5′″. In the example shown, this other or further network 5′″ is a mobile phone network having, as an example here, the network prefix “+43668.” It is understood that the further network 5′″—like the mobile phone network 5—may likewise be virtualized as an MVNO in a MNO mobile phone network.

The service node 7 is connected both to the second mobile phone network 5 and to the further network 5′″ and may thus connect the call 10 arriving in the mobile phone network 5 on the line 12 via the connection 14 to the second call 13 set up by the further network 5′″.

In the reverse situation of the call-back from the subscriber 2 to the subscriber 1, as well, the third call 13 may be received on a line 19 of the further network 5′″ and connected to the fourth call 20 by the service node 7 via the connection 21.

The home of service node 7 here may be in the mobile phone network 5, whether this is in the MVNO network 5′ or in the infrastructure-providing MNO network 5″, and in the further network 5′″, or may even be distributed across both networks 5, 5′″, including any MVNO and MNO networks implementing them. In mobile phone networks 5, 5′″ according to the GSM, UMTS, or LTE standard, the service node 7 may be implemented for example in a central Mobile Services Switching Center (MSC) of one of the networks 5, 5′″ and connected to the Mobile Services Switching Center of the other network 5′″, 5 via a data connection, or it is separated from the MSC of the networks 5, 5′″ and each is connected thereto via a data connection. The functionality of the service node 7 may also be jointly realized using one or a plurality of the MSCs or subsequent tasks.

### CONCLUSION

The disclosed subject matter is not limited to the illustrated embodiments, but instead includes all variants, modifications, and combinations thereof that fall within the scope of the attached claims.

1. A method for setting up a call from a subscriber having a first caller identification to a mobile station to which a first dial number in a first mobile phone network is assigned, comprising:
storing an association between the first dial number and a second dial number assigned in a second mobile phone network, in a service node of the second mobile phone network;
receiving a first call which is directed to the second dial number and contains the first caller identification, in the second mobile phone network;
determining the first dial number associated with the second dial number from the stored association and generating a second caller identification comprising a network prefix of the second mobile phone network and the first caller identification; and,
setting up a second call from the second mobile phone network, or another mobile or fixed phone network, to the mobile station addressed by the first dial number and connecting the first call to the second call, wherein the second caller identification is transmitted in the second call.

2. The method according to claim 1, further comprising:
storing at least one further association between the first dial number and a respective further second dial number assigned in the second mobile phone network, in the service node, wherein for each stored association of a first dial number an association identifier is assigned;
wherein the second caller identification also comprises the association identifier.

3. The method according to claim 1, wherein the first call addressed to the second dial number is detected by means of the network prefix of the second mobile phone network and directed thereto, where it is received at a line of the second mobile phone network and from there connected to the second call.

4. The method according to claim 1, wherein the second dial number is registered in the home location register of the second mobile phone network, and in that the first call addressed to the second dial number is directed by means of the home location register, or information derived therefrom, to the second mobile phone network, where it is received at a line of the second mobile phone network and from there connected to the second call.

5. The method according to claim 1, wherein the second call is only set up and the first call is only connected when the first caller identification is included in an admission list or not included in a blocking list, the admission list or blocking list, respectively, being stored in the service node with respect to the first dial number.

6. The method according to claim 5, further comprising:
storing at least one further association between the first dial number and a respective further second dial number assigned in the second mobile phone network, in the service node, wherein for each stored association of a first dial number an association identifier is assigned;
wherein the second caller identification also comprises the association identifier; and wherein for each second dial number associated with a first dial number an individual admission or blocking list is stored in the service node, wherein the respective admission or blocking list to be applied is determined by means of that second dial number to which the first call is directed.

7. A method for setting up a call from a mobile station to which a first dial number in a first mobile phone network is assigned, to a subscriber, which has a further dial number, comprising:
storing an association between the first dial number and a second dial number assigned in a second mobile phone network in a service node of the second mobile phone network;
receiving a call which contains the further dial number in its destination dial number and the first dial number as caller identification, in the second mobile phone network;
extracting the further dial number from the destination dial number, determining the second dial number associated with the first dial number from the association stored in the service node, and generating a further caller identification comprising the second dial number; and,
setting up a further call from the second mobile phone network, or a further mobile or fixed phone network, to the subscriber addressed by the extracted further dial number and connecting the call to the further call, wherein the further caller identification is transmitted in the further call.

8. The method according to claim 7, further comprising:
storing at least one further association between the first dial number and a respective further second dial number assigned in the second mobile phone network, in the service node, wherein for each stored association of a first dial number an association identifier is assigned, and wherein the destination dial number also contains the association identifier;
wherein in the step of extracting also the association identifier is extracted from the destination dial number; and,
wherein in the step of generating the further caller identification the second dial number associated with the first dial number is determined by means of the association identified by the extracted association identifier.

9. A method for setting up a call from a mobile station, to which a first dial number in a first mobile phone network is assigned, to a subscriber having a further dial number, comprising:
storing an association between the first dial number and a second dial number assigned in a second mobile phone network in a service node of the second mobile phone network;
receiving a call which contains a predetermined dial number in the second mobile phone network and/or a first part of the further dial number in its destination dial number and the first dial number as caller identification, in the second mobile phone network;
receiving a sequence of dialing tones, which sequence codes the second part of the further dial number and, if not already contained in the destination dial number, also the first part of the further dial number, via the received call, and decoding the sequence in the service node;
extracting the further dial number from the destination dial number and from the decoded sequence, determining the second dial number associated with the first dial number from the association stored in the service node, and generating a further caller identification comprising the second dial number; and,
setting up a further call from the second mobile phone network, or a further mobile or fixed phone network, to the subscriber addressed by the extracted further dial number and connecting the call to the further call, wherein the further caller identification is transmitted in the further call.

10. The method according to claim 9, further comprising:
storing at least one further association between the first dial number and a respective further second dial number assigned in the second mobile phone network, in the service node, wherein for each stored association of a first dial number an association identifier is assigned, and wherein either the destination dial number or the sequence also contains the association identifier;
wherein in the step of extracting also the association identifier is extracted; and,
wherein in the step of generating the further caller identification the second dial number associated with the first dial number is determined by means of the association identified by the extracted association identifier.

11. The method according to claim 1, further comprising: for a subsequent calling back of the subscriber from the mobile station:
receiving a third call which contains the second caller identification as destination dial number and the first dial number as third caller identification, in the second mobile phone network;
extracting the first caller identification from the destination dial number; and,
setting up a fourth call from the second mobile phone network, or a further mobile or fixed phone network, to the subscriber addressed by the extracted first caller identification and connecting the third call to the fourth call.

12. The method according to claim 11, further comprising:
determining the second dial number associated with the first dial number from the association stored in the service node, and generating a fourth caller identification comprising the determined second dial number;
wherein the fourth caller identification is transmitted in the fourth call.

13. The method according to claim 12, comprising:
storing at least one further association between the first dial number and a respective further second dial number assigned in the second mobile phone network, in the service node, wherein for each stored association of a first dial number an association identifier is assigned;
wherein the second caller identification also comprises the association identifier;
wherein in the step of extracting also the association identifier is extracted from the destination dial number; and,
wherein in the step of generating the fourth caller identification the second dial number associated with the first dial number is determined by means of the association identified by the extracted association identifier.

14. The method according to claim 7, wherein the call is detected by means of the network prefix of the second mobile phone network and directed thereto, where it is received at a line of the second mobile phone network and connected from there to the fourth call.

15. The method according to claim 1, wherein the second mobile phone network is virtualized as a Mobile Virtual Network Operator in a third mobile phone network.

16. The method according to claim 9, wherein the call is detected by means of the network prefix of the second mobile phone network and directed thereto, where it is received at a line of the second mobile phone network and connected from there to the fourth call.

17. The method according to claim 7, wherein the second mobile phone network is virtualized as a Mobile Virtual Network Operator in a third mobile phone network.

18. The method according to claim 9, wherein the second mobile phone network is virtualized as a Mobile Virtual Network Operator in a third mobile phone network.
